(19) United States
(12) Patent Application Publication
(10) Pub. No.: US 2006/0074816 A1
(43) Pub. Date: Apr. 6, 2006

(54) Information processing device, information processing method, computer-readable recording medium containing information processing program and computer program product

(76) Inventors: Toru Hibara, Ibaraki (JP); Koichi Hashimoto, Ibaraki (JP); Michael Mehigan, Ibaraki (JP)

Correspondence Address: NATH & ASSOCIATES, 112 South West Street, Alexandria, VA, 22314, US

(21) Appl. No.: 10/518,411

(22) PCT Filed: Jun. 20, 2003
(86) PCT No.: PCT/JP03/07876

§ 371 Date: Dec. 17, 2004

(30) Foreign Application Priority Data
Jun. 21, 2002 (JP) 2002-181808

(51) Int. Cl. G06Q 10/00

(52) U.S. Cl. 705/400

(57) ABSTRACT

An information processing apparatus for transmitting inputted image data to a printing machine connected via an electronic network and making the printing machine execute printing, the information processing apparatus includes: a cost information register section for registering printing cost information for each of a plurality of printing machines connected via the electronic network; an area coverage calculation section for calculating an area coverage by image forming material defined by an area of a print sheet covered with image forming material when printing the image data on the print sheet; and a printing cost calculation section for calculating a printing cost for printing the image data, based on the area coverage by image forming material, printing cost information for each of the plurality of printing machines, and a print count of the image data.

### TECHNICAL FIELD

The present invention relates to an information processing apparatus, an information processing method, a computer-readable recording medium having an information processing program recorded thereon, and a computer program product, which are suitable, for example, for a network image scanner which optically reads an image from a document and transmits the obtained image data to a printing machine connected thereto via an electronic network, or for a network printer driver to transmit an electronic document, edited by document processing program and the like on the information processing apparatus, to the printing machine connected thereto via the electronic network.

### BACKGROUND ART

Heretofore, as it is shown in Japanese Patent Laid-open No. S64-72189, there is a technology known to minimize a total printing cost by automatically selecting a printing machine of the minimum printing cost incurred, depending on a print count, from a system consisting of various kinds of printing machines such as a dry type copying machine, a stencil printing machine, and the like.

A stencil printing machine can print about ten thousand print sheets out of a perforated stencil sheet by once making the perforated stencil sheet from a stencil sheet. Here, a total printing cost, hereafter referred to simply as a printing cost, when using a stencil printing machine with a built-in scanner, including a stencil sheet cost, an image forming material (ink) cost depending on a print count (mean “the number of prints”) and the like, as well as a printing unit price (printing cost per print sheet) is shown in FIG. 25. It is to be noted that data in the example shown in FIG. 25 is based on the result obtained when printing an image data, in which an area coverage by image forming material is 10%, on A4 size print sheet. The term “Area Coverage” indicates a spatial ratio of the adhered image forming material such as ink on a surface of a print sheet, and the term is equivalent to “printing ratio” in the case of printing characters, for example.

As shown in FIG. 25, the printing unit price is “30.1 Yen” when the print count is “one print sheet.” If the print count goes up to “2,000 print sheets” the printing unit price becomes “1.1 Yen.” As it is shown above for a case of a stencil printing machine, the printing unit price gets smaller with increasing the amount of the print count.

On the other hand, for an electrostatic type copier, the printing cost is calculated based on the predetermined printing unit price for copying one print sheet. This charging method is commonly called “price per performance” charging. Therefore, for example, when using a printing system including an electrostatic type copier costing “6 Yen” of the printing unit price and the stencil printing machine shown in FIG. 25, in accordance with a selection criterion in which the electrostatic type copier is selected if the print count is “five print sheets or less”, and the stencil printing machine is selected if the print count is “six print sheets or more”. With this selection criterion, it is possible to print with the minimum printing cost.

However, a following problem will come up, if there are differences in the area coverage by image forming material (ink).

FIG. 26 shows the printing cost and the printing unit price in a stencil printing machine shown in FIG. 25, in the case of printing image data with 20% area coverage by image forming material (ink) on A4 size print sheet, where the total printing cost consist of, such as a cost for a stencil sheet, image forming material (ink) calculated for each print count, print count and the like.

As shown in FIG. 26, in the case of “20%” area coverage by image forming material (ink), the printing unit price becomes “less than 6 Yen” if the print count becomes “7 print sheets or more.” Therefore, with “20%” area coverage by image forming material (ink), when using a printing system including an electrostatic type copier costing “6 Yen” of the printing unit price and a stencil printing machine shown in FIG. 26, it is impossible to perform printing with the minimum cost unless selection is made with a criterion in which the electrostatic type copier is selected if the print count is “six print sheets or less,” and the stencil printing machine is selected if the print count is “seven print sheets or more,” this criterion being different from that of “10%” area coverage by image forming material (ink).

As it has been explained above, in the conventional technologies for selecting a printing machine, it is the observation that the printing has not always been performed in the minimum printing cost, and reasonable selection has not always been made for printing machines.

### DISCLOSURE OF THE INVENTION

The present invention is made in view of solving the problems described above. It is an object of the present invention to provide information processing apparatus, information processing method, a computer-readable recording medium having information processing program recorded thereon, and computer program product, by which it is made possible to make selection processing of a reasonable printing machine.

An information processing apparatus, according to an embodiment of the present invention, transmits inputted image data to a printing machine connected via an electronic network and makes the printing machine execute printing. The information processing apparatus is characterized by including: a cost information register section for registering printing cost information for each of a plurality of printing machines connected via the electronic network; an area coverage calculation section for calculating an area coverage by image forming material defined by an area of a print sheet covered with image forming material when printing the image data on the print sheet; and a printing cost calculation section for calculating a printing cost for printing the image data, based on the area coverage by image forming material, printing cost information for each of the plurality of printing machines, and a print count of the image data.

A computer-readable recording medium, according to an embodiment of the present invention, is a computer-readable recording medium on which an information processing program transmitting inputted image data to a printing machine connected via an electronic network and making the printing machine execute printing is recorded, characterized in that the information processing program causes an information processing apparatus to execute: a cost information register process for registering printing cost information for each of a plurality of printing machines connected via the electronic network; an area coverage calculation process for calculating an area coverage by image forming material defined by an area of a print sheet covered with image forming material when printing image data on the print sheet; and a printing cost calculation process for calculating a printing cost for printing the image data, based on the area coverage by image forming material, printing cost information for each of the plurality of printing machines, and a print count of the image data.

With the configuration shown above, when the plurality of printing machines are connected via the electronic network, it is made possible to know the printing cost necessary to print the image data by the printing machine. Accordingly, a user can perform printing processing reasonably by selecting an appropriate printing machine among the plurality of printing machines according to a budget. Particularly, even if the printing machine, such as a stencil printing machine, the printing unit price of which varies depending on the print count, is included in the plurality of printing machines, it is made possible to accurately calculate the printing cost when the image data are printed.

In addition, it is preferable to select a printing machine of the minimum printing cost among the plurality of printing machines, and to transmit the image data to the printing machine. With the configuration shown above, it is made possible to automatically select a printing machine of the minimum printing cost among the plurality of printing machines connected via the electronic network, and to automatically transmit the image data to the printing machine. Therefore a user can perform printing processing with the minimum printing cost even without recognizing the printing cost incurred in each of the printing machines connected via the electronic network.

Further, it is preferable to calculate an area coverage by image forming material based on a sampled image which is generated by sampling the image data at a predetermined sampling space. With this constitution, the amount of image data used in calculation for the area coverage by image forming material will be made smaller than that of the image data for printing, and thus the time for calculation of the area coverage by image forming material can be reduced.

Still further, it is more preferable for the printing cost calculation section to calculate the printing cost with a print density of the image data in addition to the area coverage by image forming material, printing cost information, and the print count of the image data. With this constitution, it is made possible to calculate the printing cost more accurately regarding a printing machine whose unit price for printing varies depending on the print density among others.

Further, such a configuration can be adopted that the image input apparatus which transmits the inputted image data from the image reading section to the printing machine connected via the electronic network is employed as the information processing apparatus, and a firmware program for the image input apparatus is employed as the information processing program.

Alternatively, such a configuration can be adopted that a PC (Personal Computer) transmitting the inputted image data from an application program to the printing machine connected via the electronic network is employed as the information processing apparatus, and a virtual printer driver which receives image data transmitted from the application program and transmits the image data to a printer driver program for a printing machine is employed as the information processing program.

Further more, such a configuration can be adopted that a server which transmits the inputted image data from another information processing apparatus connected via the electronic network to a printing machine connected via the same electronic network is employed as the information processing apparatus, and a virtual printer driver which receives the image data transmitted from the application program and transmits the image data to a printer driver program for the printing machine is employed as the information processing program.

### BRIEF DESCRIPTION OF THE DRAWINGS

FIG. 1 is a schematic diagram showing a configuration of a printing system which is a first embodiment of the present invention.

FIG. 2 is a block diagram showing a configuration of a firm ware program of an image scanner in the first embodiment shown in FIG. 1.

FIG. 3 is a diagram showing an example of data, in table form, to be stored in a cost information register section shown in FIG. 2.

FIG. 4 is a diagram showing an example of data, in table form, to be stored in a printer information register section shown in FIG. 2.

FIG. 5 is a block diagram showing a detailed configuration of an area coverage calculation section shown in FIG. 2.

FIG. 6 is a flowchart showing a printer selection method conducted by the image scanner of the first embodiment.

FIG. 7 is a flowchart showing a detailed processing of an image forming material covering area calculation method shown in FIG. 6.

FIG. 8 is a diagram showing printing cost and printing machine of the minimum printing cost in table form, here printing cost is listed for each printing machine and for each area coverage by image forming material when the printing is performed in A4 size print sheet using the printing system in the first embodiment.

FIG. 9 is a schematic diagram showing a configuration of a printing system which is a second embodiment of the present invention.

FIG. 10 is a diagram in table form showing an example of data to be stored in a cost information register section of an image scanner shown in FIG. 9, and also showing printing costs and printing machines of the minimum printing cost, here printing cost is listed for each printing machine and for each area coverage by image forming material.

FIG. 11 is a schematic diagram showing a configuration of a printing system which is a third embodiment of the present invention.

FIG. 12 is a schematic diagram showing a configuration of an information processing program to be installed in a PC shown in FIG. 11.

FIG. 13 is a block diagram showing a configuration of a virtual printer driver shown in FIG. 12.

FIG. 14 is a flowchart showing a printing process of the PC shown in FIG. 11.

FIG. 15 is a flowchart showing image data transmission processing shown in FIG. 14.

FIG. 16 is a schematic diagram showing a print property dialogue box in the third embodiment.

FIG. 17 is a schematic diagram showing a screen display for printing cost in the third embodiment.

FIG. 18 is a diagram in table form showing an example of data to be stored in the cost information register section of an image scanner in a printing system of a fourth embodiment, when a print density of the printing machines in FIG. 1 can be specified.

FIG. 19 is a diagram in table form showing printing cost and printing machine of the minimum printing cost in the printing system of the fourth embodiment, here printing cost is listed for each printing machine and for each area coverage by image forming material, when “light” in a print density mode selection is selected as shown in FIG. 18.

FIG. 20 is a diagram in table form showing printing cost and printing machine of the minimum printing cost in the printing system of the fourth embodiment, here printing cost is listed for each printing machine and for each area coverage by image forming material, when “dense” in a print density mode selection is selected as shown in FIG. 18.

FIG. 21 is a schematic diagram showing a printing system which is a fifth embodiment of the present invention.

FIG. 22 is a block diagram showing a configuration of an information processing program to be installed in a PC and a server shown in FIG. 21.

FIG. 23 is a block diagram showing a configuration of a virtual printer driver to be installed in a PC shown in FIG. 22.

FIG. 24 is a block diagram showing a configuration of a background application to be installed in a server shown in FIG. 22.

FIG. 25 is a diagram in table form showing each cost, the total printing cost, and a printing unit price when image data are printed with 10% area coverage by ink in A4 size print sheet by use of a stencil printing machine, where the cost consist of such as a cost for a stencil sheet calculated for each print count, image forming material, the print sheet and the like.

FIG. 26 is a diagram in table form showing each cost, the total printing cost, and a printing unit price when image data are printed with 20% area coverage by ink in A4 size print sheet by use of a stencil printing machine, where the cost consist of such as a cost for a stencil sheet calculated for each print count, image forming material, the print sheet and the like.

### BEST MODE FOR CARRYING OUT THE INVENTION

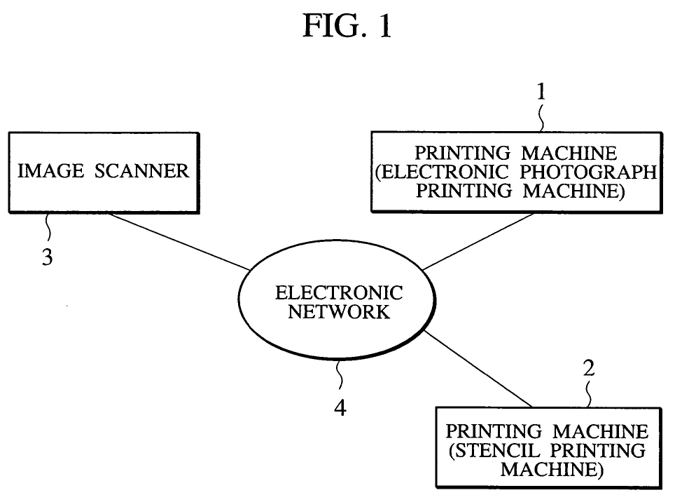

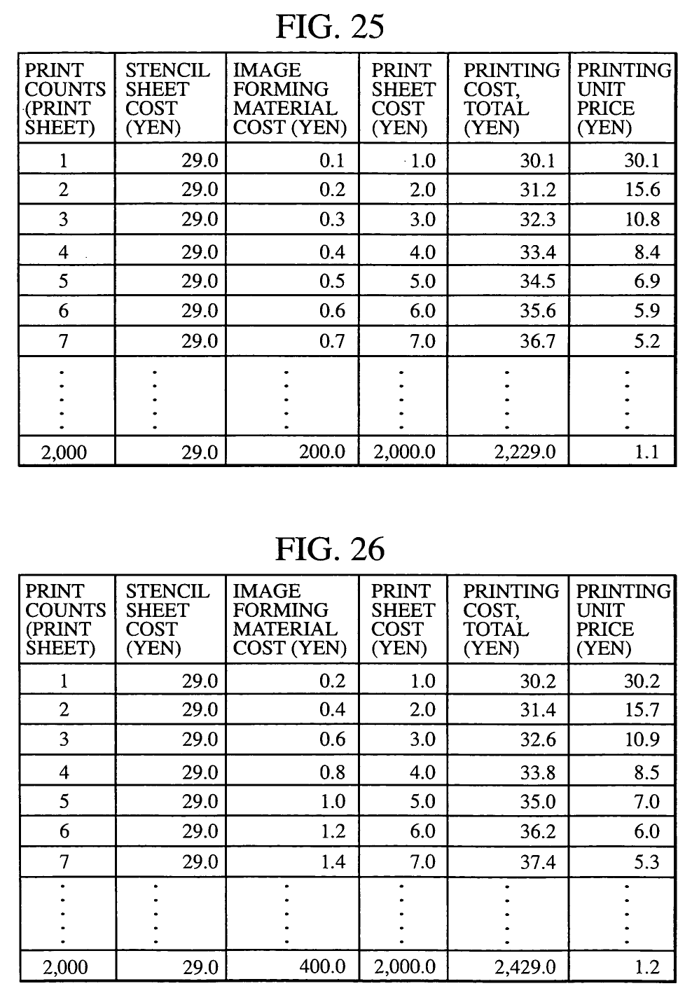

Hereinafter, referring to FIGS. 1 to 26, detailed explanations will be given of embodiments of the present invention. Incidentally, the same numerals and symbols will be used to designate the same or similar parts and components all through the drawings, so that the description will be omitted or simplified.

### First Embodiment

<Configuration of Printing System>

A printing system shown in FIG. 1 is configured with a printing machine 1, a printing machine 2, and an image scanner 3 connected to each other via an electronic network 4 and thus communication between the system components is enabled.

It should be noted that the referred “electronic network” means a general communication network using the electronic communication technology. The electronic communication technology constituting a network is forming hierarchy layers. In the physical layer which is the lowest layer, signal is transmitted by wireless (electromagnetic wave) or wired means (metallic cable and optical fiber cable). In the network layer which is an upper layer over the physical layer, circuit switching, which is used in telephone communication lines, or packet switching, which is used in the Internet, is used to exchange data. In the Internet the TCP/IP (Transmission Control Protocol/Internet Protocol) is adopted as a protocol, and thus data is exchanged as TCP/IP packet data via router. As for a LAN (Local Area Network) for a narrow area such as inside the office, it is preferable to adopt a packet communication specified in IEEE 802 (IEEE 802 LAN/MAN Standards). IEEE 802 is using a protocol called CSMA/CD (Carrier Sense Multiple Access with Collision Detection) in the network layer, and it is made capable of transmission/reception of packets to/from each other between a plurality of electronic appliances.

The printing machine 1 is an electronic photograph printing machine, the printing machine 2 is a stencil printing machine, and the inputted image data from the image scanner 3 is printed on a print sheet by electronic photograph printing and by stencil printing, respectively.

The image scanner 3 is an image inputting apparatus (=information processing apparatus) of a scanning type and the operation of the image scanner 3 is controlled by firmware program (=information processing program) stored in an internal ROM (Read Only Memory), which is not illustrated. The ROM includes magnetic or optical recording medium, or record means such as a semiconductor memory and the like. It can be configured so that program and also data to be stored in the recording means or the record means are received partly or as a whole via the electronic network 4.

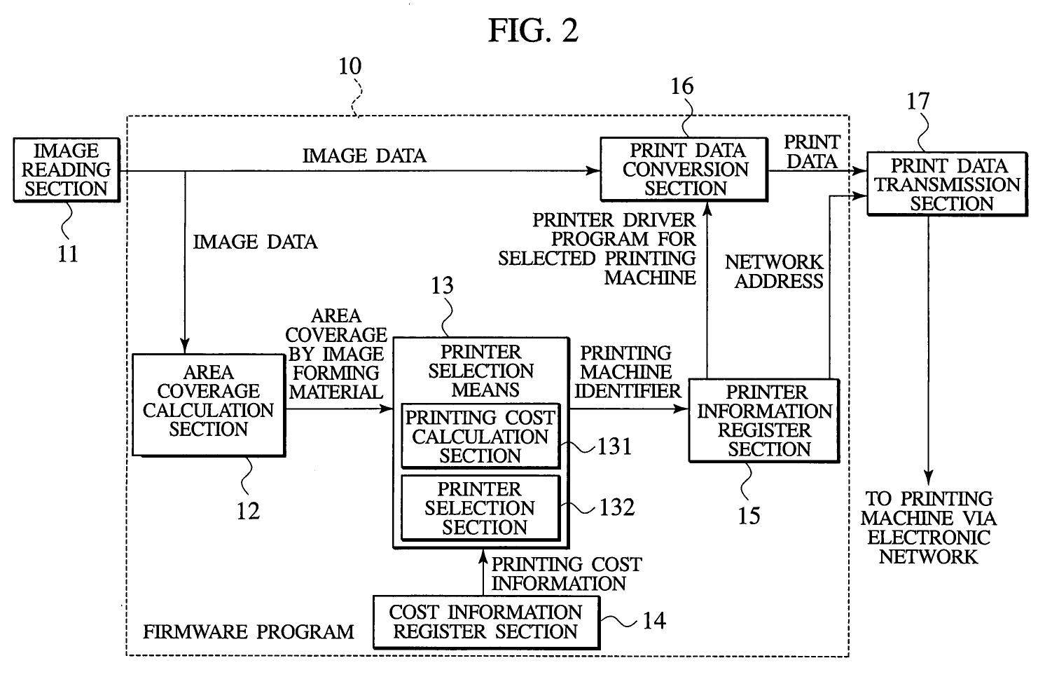

FIG. 2 shows a configuration example of a firmware program 10 stored in the ROM which is included in the image scanner 3. An image reading section 11 is a device in which an image is read in such a way that an original is irradiated with light, and the reflected light after passing through an optical system is captured by an image sensor, such as CCD (Charge Coupled Device) or MOS (Metal Oxide Semiconductor), the reflected light quantized subsequently. The read image data is outputted to an area coverage calculation section 12 and a print data conversion section 16.

The area coverage calculation section 12 calculates an area coverage by image forming material based on the image data outputted from the image reading section 11. Details will be explained hereinafter.

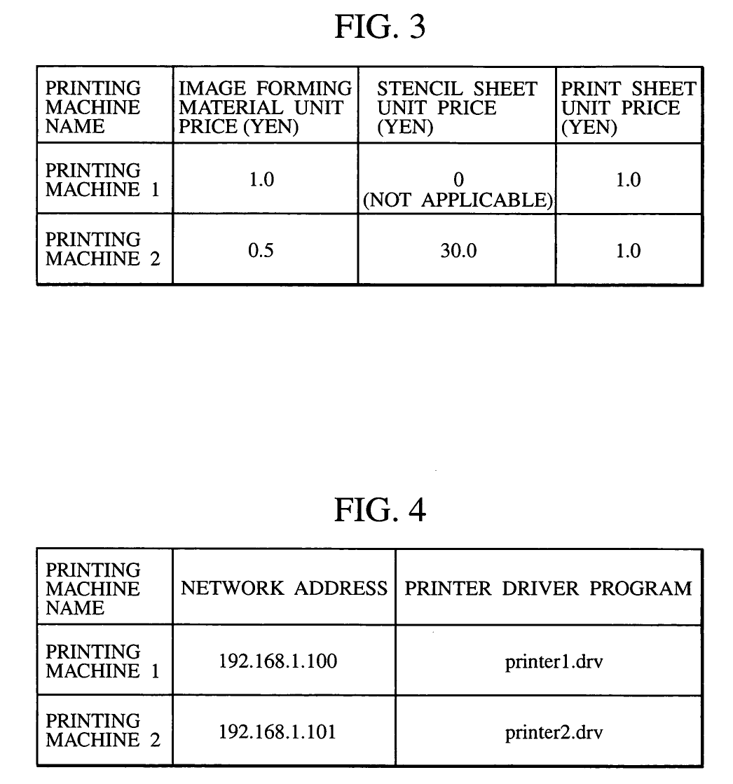

A cost information register section 14 registers, for example, printing cost information of the printing machine 1 and the printing machine 2, such as image forming material unit price, print sheet unit price, and stencil sheet unit price, as shown in FIG. 3.

It is to be noted that “image forming material” referred here means material used in printing an image on the print sheet, such as ink and toner and the like. Further, the “printing cost information” includes stencil sheet unit price information if a printing machine is the stencil printing machine. Furthermore, if there is a distinct difference of power consumption among the printing machines, the cost for the power consumption of the printing machines at the time of printing may be included in calculation.

Printer selection means 13 includes a printing cost calculation section 131 and a printer selection section 132. The printing cost calculation section 131 calculates the printing cost for each printing machine based on the print count of image data specified by a user, the area coverage by image forming material calculated by the area coverage calculation section 12, and the printing cost information registered in a cost information register section 14. The printer selection section 132 selects a printing machine that can print with the minimum printing cost and outputs the selected printing machine identifier (for example, a printing machine name) to a printer information register section 15.

The printer information register section 15 registers, for example as shown in FIG. 4, printer driver program for the printing machine 1 and the printing machine 2 connected to each other via the electronic network 4, and network address, such as IP address, of respective printing machine on the electronic network 4. After that, based on the printing machine identifier outputted from the printer selection means 13, the printer information register section 15 outputs a printer driver program of the selected printing machine to the print data conversion section 16, and further outputs a network address of the selected printing machine to a print data transmission section 17.

The print data conversion section 16 generates printing data using both the image data and printer driver program, and transmits it to the print data transmission section 17. Here the image data is outputted from the image reading section 11, and the printer driver program is outputted from the printer information register section 15.

The print data transmission section 17 transmits the print data generated by the print data conversion section 16 to a printing machine with a network address which is the output of the printer information register section 15 via the electronic network 4.

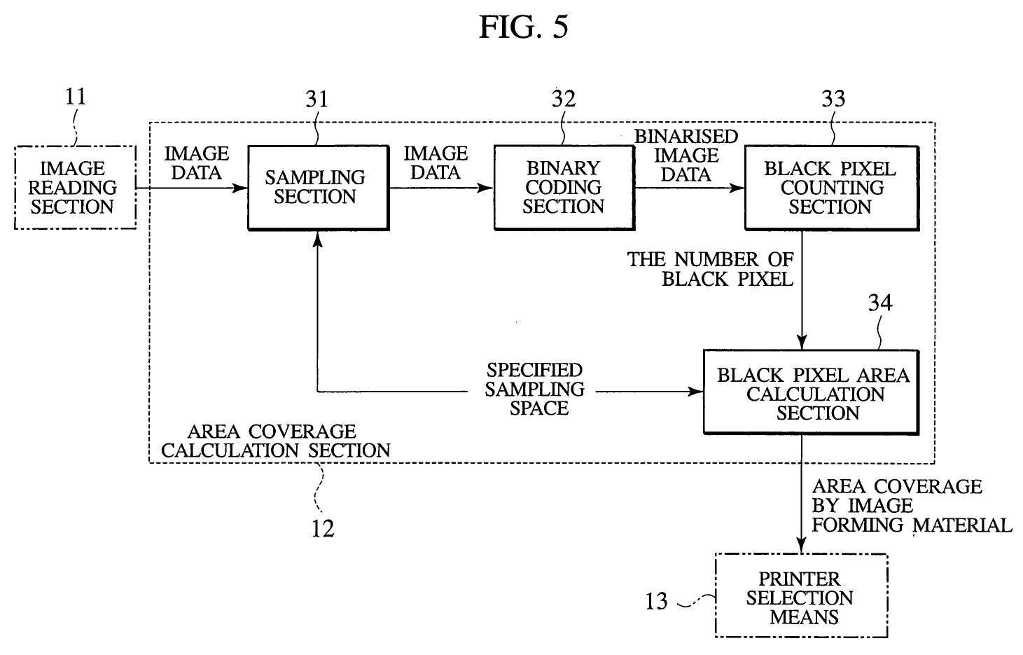

FIG. 5 shows a detailed configuration of the area coverage calculation section 12. The area coverage calculation section 12 consists of a sampling section 31, a binary coding section 32, a black pixel counting section 33, and a black pixel area calculation section 34.

The sampling section 31 re-samples the image data outputted from the image reading section 11 at a specified sampling space.

The binary coding section 32 converts image data that is re-sampled at a specified sampling space in the sampling section 31 into binarized image data, that is, black pixels and white pixels.

The black pixel counting section 33 counts the number of black pixels among the binarized image data converted by the binary coding section 32.

The black pixel area calculation section 34 calculates an area coverage by image forming material at the time of printing, which corresponds to the number of black pixels, from the number of black pixel calculated by the black pixel counting section 33, the resolutions of both of the image reading section 11 and the printing machine, and the specified sampling space, and outputs the area coverage to the printer selection means 13.

<Selection Operation of Printing Machine>

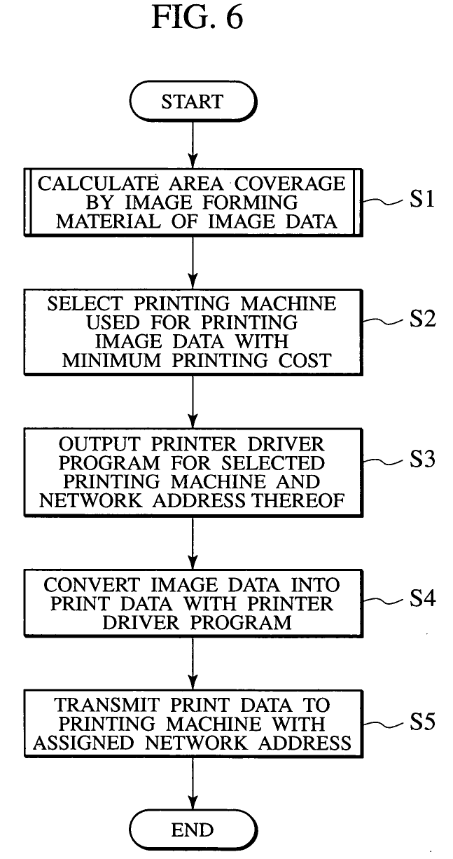

Next, referring to the flowchart in FIG. 6, an operation of the image scanner 3 is explained in detail when selecting a printing machine with the minimum printing cost between the printing machine 1 and the printing machine 2 connected to each other via the electronic network 4.

In the flowchart shown in FIG. 6, the firmware program 10 generates image data by reading an image out of a document at the image reading section 11, and starts coinciding with the input by a user for instructions of printing such as the number of prints.

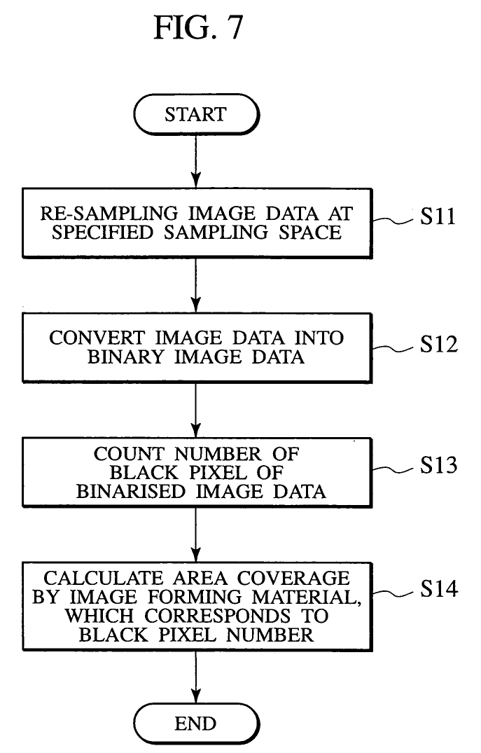

In the process in Step S1, the area coverage calculation section 12 calculates an area coverage by image forming material of the generated image data at the image reading section 11. More specifically, the calculation process of the area coverage by image forming material is conducted following the flowchart in FIG. 7.

In the process in Step S11 of the flowchart shown in FIG. 7, the sampling section 31 re-samples the image data at the specified sampling space. Here, the “specified sampling space” means a sampling space so as to calculate the area coverage by image forming material in sufficient accuracy when printing by a printing machine. As a specific specified sampling space, about “200 dpi (dot per inch)” in terms of printing resolution is sufficient in practice.

In the case of “600 dpi” of resolution for both image reading section and printing machine, it is sufficient that the specified sampling interval is “three pixels (sampling one out of three pixels)” in both main and sub scanning directions for the read image data by the image reading section.

It is to be noted that a smaller sampling space makes the calculation time longer although the accuracy is increased. On the other hand, a larger sampling space makes the calculation time shorter although the accuracy is decreased. Therefore, it is preferable to properly decide the specified sampling space considering the balance between the required accuracy and calculation time for the area coverage by image forming material.

In the process in Step S12, the binary coding section 32 converts the image data re-sampled at the sampling section 31 into the binarized image data consisting of black pixels and white pixels.

In addition, it is preferable that a binary coding processing be performed in a similar processing method adopted in the printer driver programs for the printing machine 1 and the printing machine 2 connected to each other via the electronic network 4. Generally speaking, in a case of reading image data from a document, character and picture often coexit in the image data. In some cases, the document often includes dot images. In this occasion, an error diffusion method is preferably adopted for processing method for the binarize process. With the error diffusion method, a mimic realization of tone of dot images is possible by area coverage modulation. At the same time, good reproduction of thin lines such as characters is realized. In addition, in the case of dot images, it is made possible to inhibit generation of moire patterns.

In the process in Step S13, the black pixel counting section 33 counts the number of black pixels of the binarized image data which was converted at the binary coding section 32.

In the process in Step S14, the black pixel area calculation section 34 calculates the area coverage by image forming material at printing which corresponds to the number of black pixels, based on the counted number of black pixels, resolution of printing machine equivalent, and the specified sampling interval. It is to be noted that the “resolution of printing machine equivalent” denotes a resolution on the assumption that the re-sampled image is printed in a required size by a printing machine.

Further, when the resolution of printing machine is denoted as “R1” and the sampling space for re-sampling is denoted as “M”, the resolution “R” of printing machine equivalent is given as,
R=R1/M.

Under the denotation that the resolution of printing machine equivalent is “R”, and when the resolution of printing machine is denoted as “R1” and the sampling space is denoted as “M”, the specified sampling space “M1” in the case of re-sampling image that is read from the image reading section 11, M1=R2/R. Here, “R2” is a resolution at the image reading section 11. Thus, the sampling space “M” for re-sampling can be formulated as an equation (1).
M=M1×R1/R2 (1)

In other words, if the resolutions in the image reading section 11 and the printing machine are equal, the specified sampling space “M1”, which is used in re-sampling image that is read from the image reading section 11, is equal to the sampling interval “M1”.

In this embodiment the area coverage by image forming material can be calculated by using an equation (2), and by putting parameters of the image data into the equation (2), the area coverage by image forming material is given.

$$S = ( A \times {N}_{black \text{-} pixel} ) / ( L1 \times L2 \times {R}^{2} ) \\ = {N}_{black \text{-} pixel} \times {( M / R1 )}^{2} \qquad ( 2 )$$

Here, “S” is the area coverage by image forming material (inch²); “A” is a print sheet area; “N_{black-pixel}” is the number of black pixels; “R” is the resolution equivalent (dpi) to that of printing machine; “R1” is the resolution of printing machine (dpi); “M” is the sampling space; “L1” is a lateral length of the print sheet (inch); and “L2” is a lateral length of the print sheet (inch).

Further, in this embodiment, a case is shown, in which the image read from the image reading section 11 is printed at equal magnification by the use of the printing machine 1 or the printing machine 2. When the image reading section 11 is equipped with means for selecting a function of enlargement and reduction of image size, an area coverage by image forming material “S2” can be calculated with an equation: S2=F×S, given that the ratio of enlargement or reduction is “F”.

With the procedures hereinbefore, a series of calculation processes (Step S1) of the area coverage by image forming material will finish.

In the process in Step S2, the printer selection means 13 calculates the printing cost for individual printing machines based on the print count specified by user, the printing cost information registered in the cost information register section 14, and the value of the area coverage by image forming material which is calculated in Step S1, and selects a printing machine of the minimum printing cost. After that, the printer selection means 13 outputs a printing machine identifier of the selected printing machine (for example, printing machine name) to the printer information register section 15.

Regarding the printing system shown in FIG. 1, the difference in the printing cost for the printing machine 1 and the printing machine 2 resides in the unit price of both image forming material (ink, toner) and a stencil sheet. Therefore, in this embodiment, the printer selection means 13 calculates the printing cost for the printing machine 1 and the printing machine 2 using an equation (3) below, and selects a printing machine of the minimum printing cost.
J=Pₘₐₛₜₑᵣ+(P_{print sheet}+Pᵢₙₖ×S)×N (3)

It is to be noted that: “J” is the printing cost; “Pₘₐₛₜₑᵣ” is the unit price of a stencil sheet; “P_{print sheet}” is the unit price of a print sheet; “Pᵢₙₖ” is the unit price of image forming material; “S” is the area coverage by image forming material (unit: inch²); and “N” is the print count.

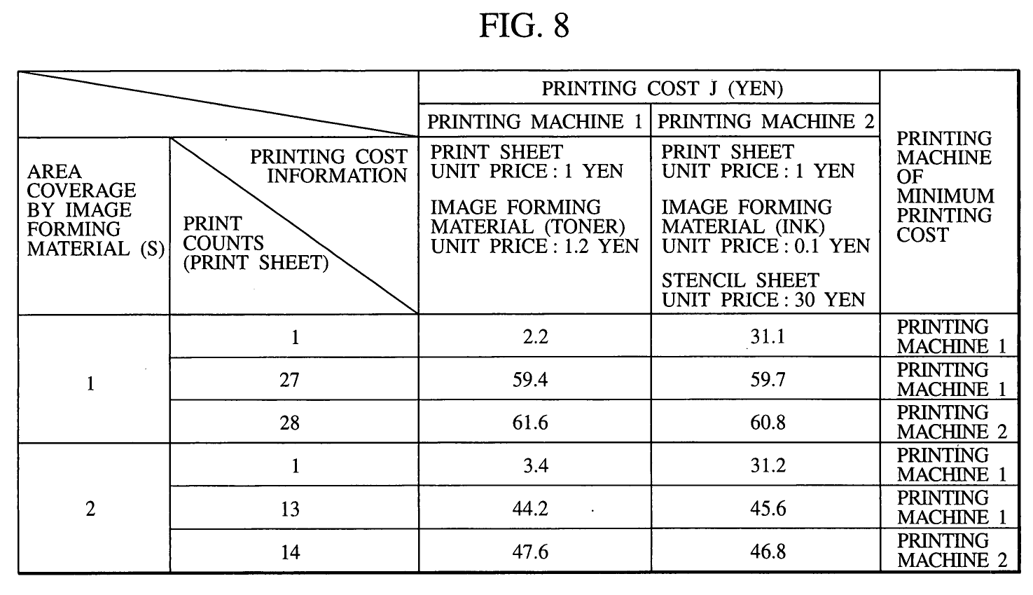

Specifically, as shown in FIG. 8, when the area coverage by image forming material is “S=1”, the printing machine 1 is selected at “27 print sheets or less” of the print count and the printing machine 2 is selected at “28 print sheets or more” of the print count. When the area coverage by image forming material is “S=2,” the printing machine 1 is selected at “13 print sheets or less” of the print count and the printing machine 2 is selected at “14 print sheets or more” of the print count.

In process in Step S3, the printer information register section 15 outputs, based on the printing machine identifier outputted from the printer selection means 13, a printer driver program of the selected printing machine to the print data conversion section 16 and also outputs a network address of the selected printing machine to the print data transmission section 17.

In the process in Step S4, the print data conversion section 16 converts an image data outputted from the image reading section 11 to print data suitable for printing by using printer driver program for the selected printing machine outputted from the printer information register section 15. Then the print data are outputted to the print data transmission section 17.

In the process in Step S5, the print data transmission section 17 transmits the converted print data at the print data conversion section 16 via the electronic network 4 to a printing machine with the network address supplied from the printer information register section 15. With those processes hereinbefore, a series of processes are finished

Thus, a printing machine that receives the print data prints with the minimum printing cost.

As shown above, in the printing system according to the first embodiment, the image scanner 3 calculates the area coverage by image forming material of image data by using the firmware program 10. Thereafter, the image scanner 3 again calculates the printing cost for a plurality of printing machines using the area coverage by image forming material obtained above, the print count, and the cost information such as the unit price of image forming material, print sheet, stencil sheet, and the like which vary depending on each printing machine. Subsequently, the image scanner 3 automatically selects a printing machine of the minimum printing cost. Accordingly, a user can print at the minimum printing cost without awareness of the printing cost.

Further, in the printing system according to the first embodiment, an area coverage by image forming material, which is an area on the print sheet covered with image forming material, is calculated by using a sampled image sampled in accordance with the predetermined sampling interval. For this reason, a size of sampled data used in calculating an area coverage by image forming material can be made smaller than print data, and thus it is possible to shorten the time necessary for calculating an area coverage by image forming material.

### Second Embodiment

<Configuration of Printing System>

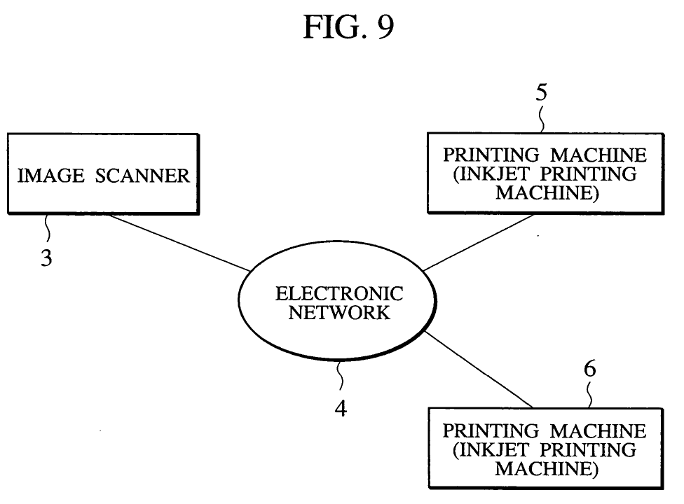

A printing system shown in FIG. 9 is configured with a printing machine 5, a printing machine 6, and an image scanner 3 connected to each other via an electronic network 4 and thus communication between the system components is enabled.

The printing machine 5 and the printing machine 6 are both inkjet monochrome printing machines, in which inputted image data from the image scanner 3 is printed on a print sheet by inkjet.

Since the configuration and operation of an image scanner 3 and an electronic network 4 are the same as those of the first embodiment, an extra explanation will be omitted. In the drawings, the same numerals and symbols will be used to designate the same components in configuration.

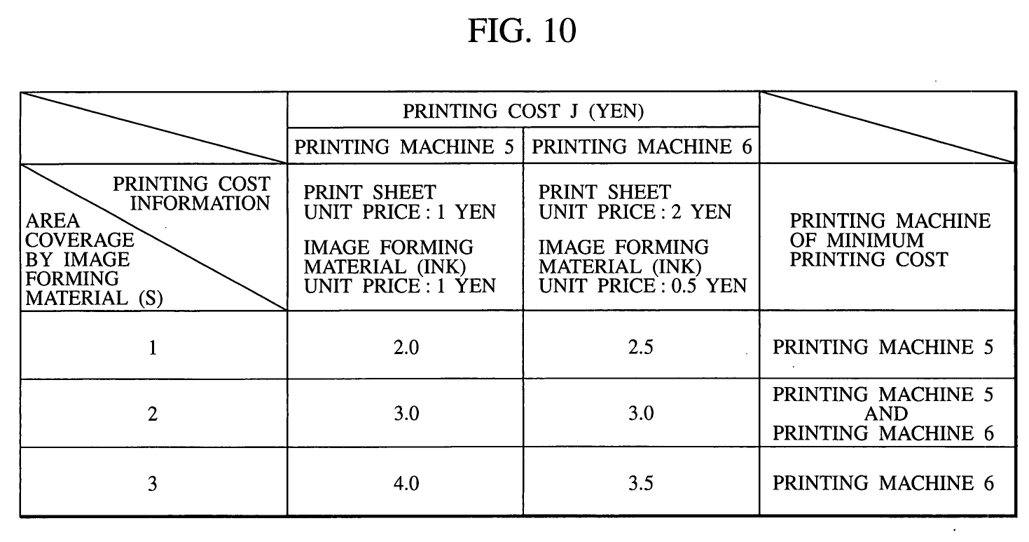

In the case of a printing system shown in FIG. 9, the difference in a printing cost between the printing machine 5 and the printing machine 6 resides in a unit price of image forming material (ink) and a print sheet as shown in FIG. 10. Therefore, in this embodiment, the printer selection means 13 in the image scanner 3 calculates the printing cost for each printing machine by using an equation (3) so as to select a printing machine to minimize the total cost of unit price of image forming material (ink) and print sheet. The printer selection means 13 then selects a printing machine that will realize the minimum printing cost.

Specifically, as shown in FIG. 10, the printing machine 5 will be selected as a printing machine of the minimum printing cost if an area coverage by image forming material is “S<2”. Given that the area coverage by image forming material is “S≧3”, then the printing machine 6 will be selected as a printing machine of the minimum printing cost. However, the area coverage by image forming material is “S=2”, either the printing machine 5 or the printing machine 6 can be selected since the both printing cost becomes the same.

As has been shown, in the printing system according to the second embodiment, the image scanner 3 calculates the area coverage by image forming material of image data by using a firmware program 10. The printing system then automatically select a printing machine of the minimum printing cost among a plurality of printing machines which have a different unit price for image forming material and a print sheet depending on the value of the area coverage by image forming material obtained above. Accordingly, it is made possible that a user can reasonably carry out printing by using the printing machine of the minimum printing cost without awareness.

### Third Embodiment

<Configuration of Printing System>

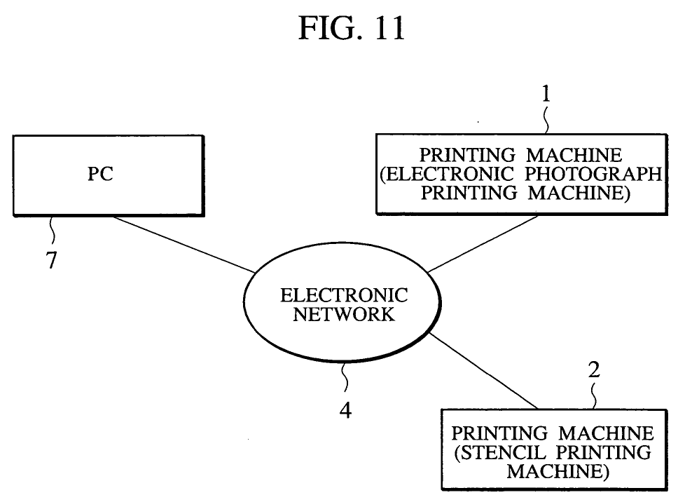

A printing system shown in FIG. 11 is configured similarly as the first embodiment in FIG. 1 except the image scanner 3 which is replaced by a PC (Personal Computer) 7.

In the printing system with this type of configuration, the invention is realized by a form of a virtual printer driver (mean “an information processing program”) installed in the PC 7.

It is to be noted that the “virtual printer driver” may be observed as it were a printer driver of the selected printing machine installed in the PC 7 by a user. However the “virtual printer driver” is not the printer driver of the selected printing machine, but is an information processing program, which will automatically select a printing machine for printing in accordance with a print command given by the user and transmit image data to the printer driver of the selected printing machine.

<Information Processing Program Constitution of PC>

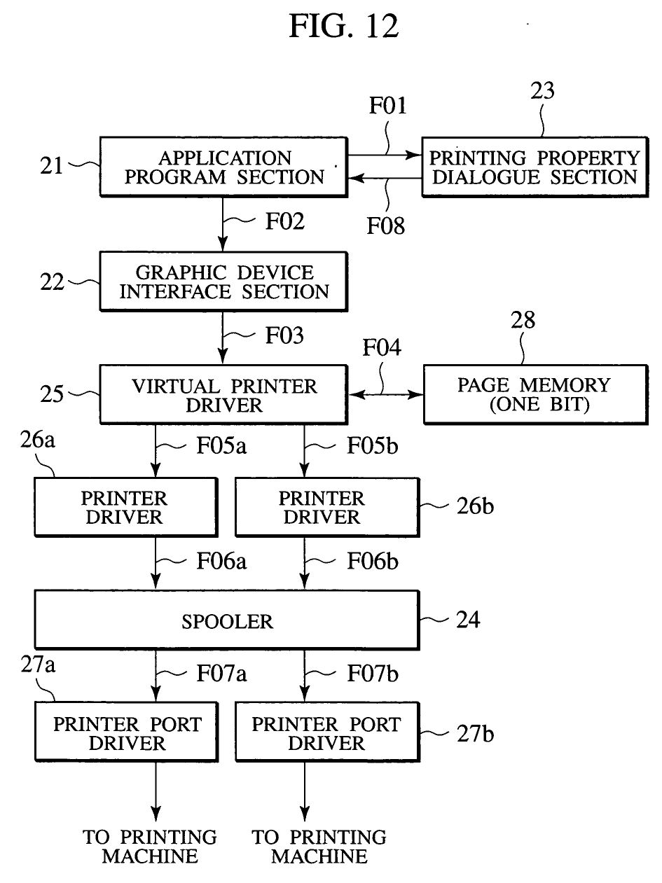

A constitution of the information processing program installed in the PC 7 includes an application program section 21; a graphic device interface section 22; a printing property dialogue section 23; a spooler 24; a virtual printer driver 25; a printer driver 26a; a printer driver 26b; a printer port driver 27a; a printer port driver 27b; and a page memory 28, as specifically shown in FIG. 12.

The application program section 21 displays a dialog box showing a printer property of the printer driver (Arrow “F01” in FIG. 12), and acquires printer property parameters (print sheet size, image processing property, print count, and the like) which are inputs by the user through the dialog box (Arrow “F08” in FIG. 12). In addition, the application program section 21 calls data drawing functions of the graphic device interface section 22, and passes (Arrow “F02” in FIG. 12) drawing data (a character code, bit map image data, illustration image data, a position coordinate to draw thereof, and the like).

The graphic device interface section 22 calls data drawing functions of the virtual printer driver 25 corresponding to the called data drawing functions (Arrow “F03” in FIG. 12).

The virtual printer driver 25 rasterizes the drawing data and extracts bit map image data in the page memory 28 (Arrow “F04” in FIG. 12).

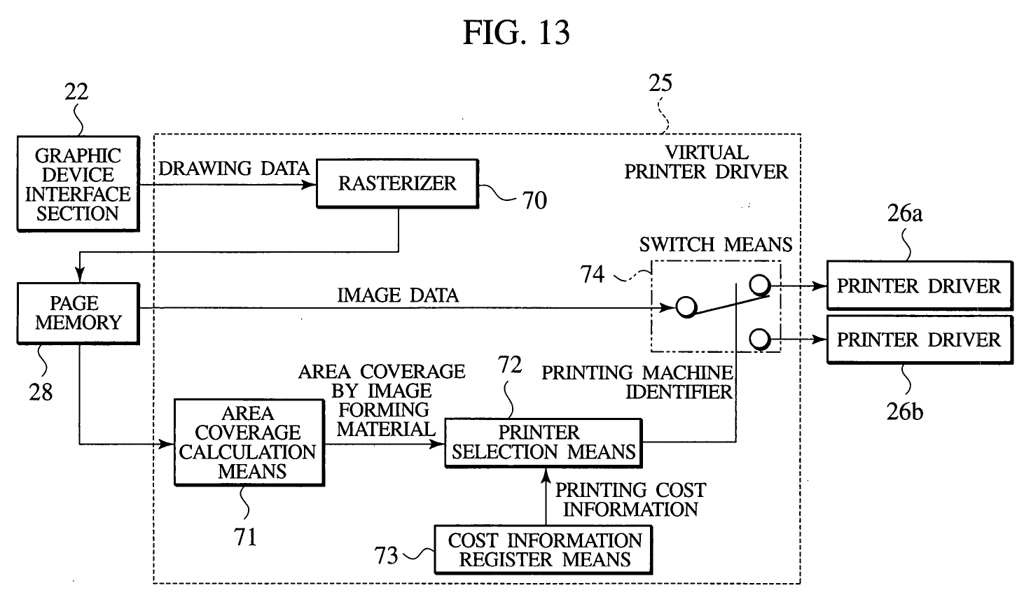

The virtual printer driver 25 includes a rasterizer 70, area coverage calculation means 71, printer selection means 72, cost information register means 73, and switch means 74, as shown in FIG. 13 as an example.

The rasterizer 70 extracts the drawing data outputted from the graphic device interface section 22 as bit map image data, and outputs it to the page memory 28.

The area coverage calculation means 71 calculates an area coverage by image forming material using bit map image data temporarily stored in the page memory 28. The area coverage calculation means 71 has the same configuration as an area coverage calculation section 12 shown in FIG. 5 except that the sampling section 31 is not included since the area coverage calculation means 71 handles bit map image data, therefore detailed explanation thereof will be omitted.

The cost information register means 73, for example as shown in FIG. 3, registers printing cost information of the printing machine 1 and the printing machine 2, such as a unit cost for image forming material per unit area, for a stencil sheet, and for a print sheet.

The printer selection means 72 calculates a printing cost of each printing machine based on a print count specified by a user, an area coverage by image forming material calculated by the area coverage calculation means 71, and printing cost information registered in the cost information register means 73. Then the printer selection means 72 selects a printing machine that can print with the minimum printing cost, and subsequently outputs an identifier of the selected printing machine to the switch means 74 as a switching signal.

The switch means 74 outputs the bit map image data from the page memory 28 to either the printer driver 26a or the printer driver 26b in a switching manner in accordance with a switching signal outputted from the printer selection means 72.

Therefore, the virtual printer driver 25 scans the page memory 28, calculates the area coverage by image forming material, and then calculates the printing cost of each printing machine depending on the calculated area coverage by image forming material and the print count, and selects a printing machine of the minimum printing cost. Further, the virtual printer driver 25 calls, either the printer driver 26a corresponding to the selected printing machine or the printer driver 26b, and converts the image data in the page memory 28 to printer commands of the selected printing machine (Arrow “F05a” or arrow “F05b” in FIG. 12).

The called printer driver, either the printer driver 26a or the printer driver 26b outputs the printer commands to the spooler 24 (Arrow “FO6a” or arrow “FO6b” in FIG. 12).

The spooler 24 records the outputted printer commands to a spool file, and outputs the printer commands to the selected printer port driver, either the printer port driver 27a or the printer port driver 27b (Arrow “FO7a” or arrow “F07b” in FIG. 12).

<Process Operation of PC>

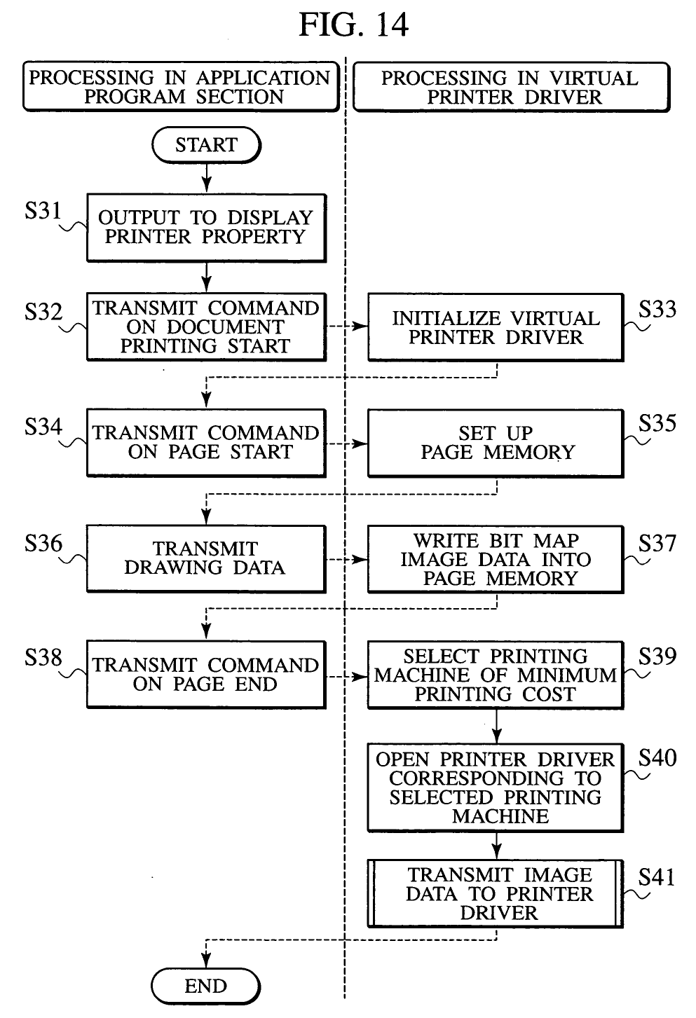

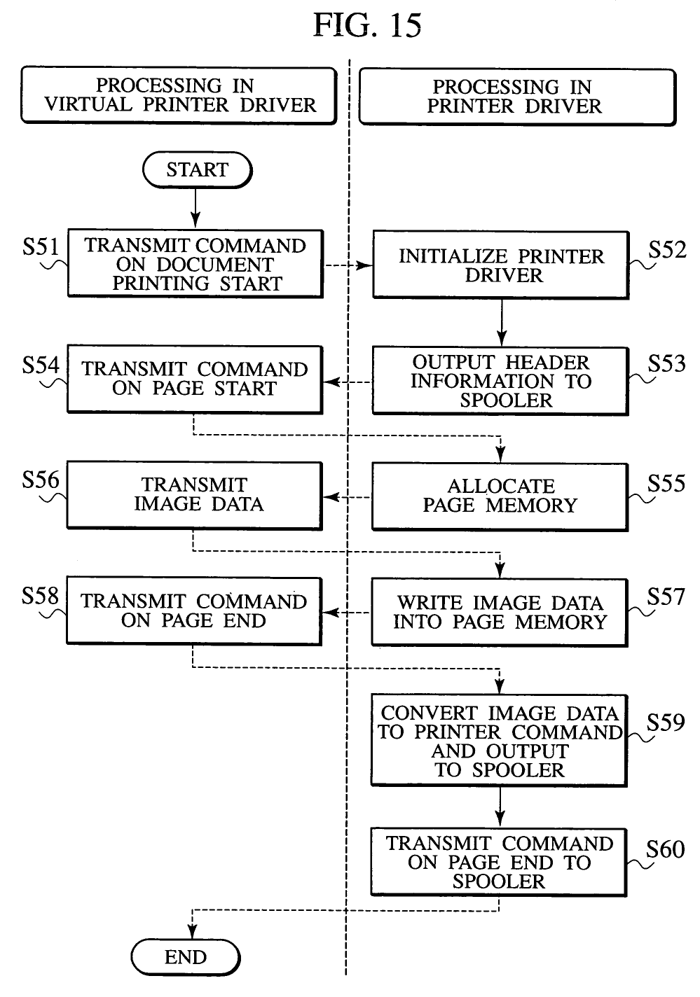

After the execution of printing process via the application program section 21 by a user, the PC 7 executes below processes following the flowchart shown in FIGS. 14 and 15.

The flowchart, shown in FIG. 14, is initiated by instructions of execution of printing process by the user via the application program section 21, and the printing process proceeds to the process in Step S31.

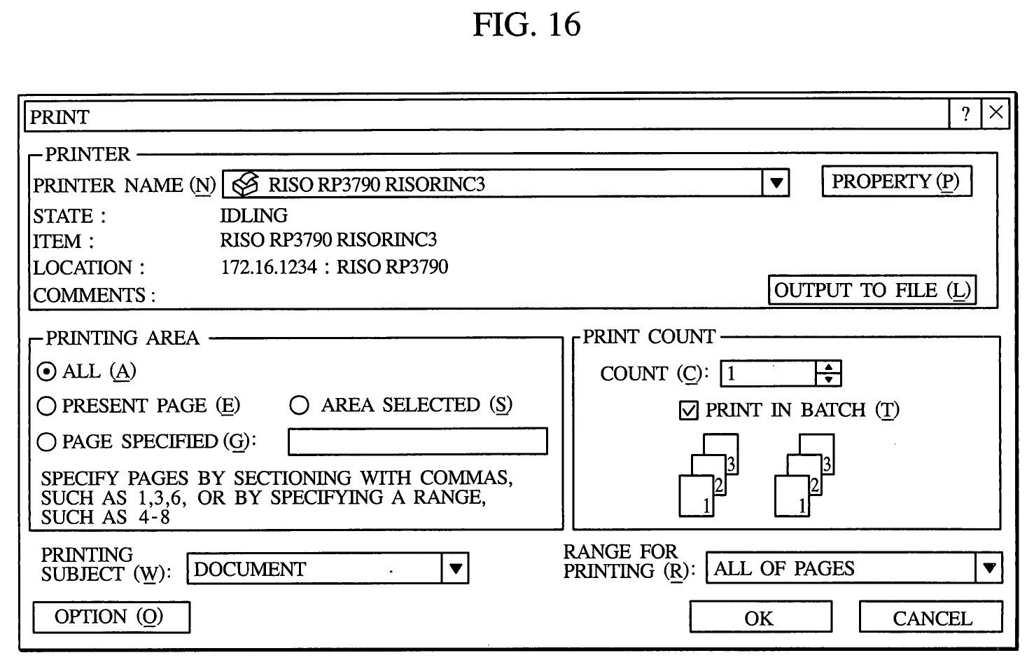

In the process in Step S31, the application program section 21 outputs a dialog box on a display such as a liquid crystal display and the like. The dialog box displays the printer property parameters of a printer driver shown in FIG. 16, for example. The user can refer to the dialog box and an option dialog box (not shown), and specifies the printer property parameters, such as a print sheet size, a print count, a direction of printing and the like. The option dialog box is displayed by operating an option button in the dialog box.

In the process in Step S32, the application program section 21 transmits a print start command to the virtual printer driver 25. In the process in Step S33, the virtual printer driver 25 initializes the virtual printer driver 25 after receiving the print start command.

In the process in Step S34, the application program section 21 transmits a page start command to the virtual printer driver 25. Subsequently, in the process in Step S35, the virtual printer driver 25 sets up the page memory 28 after receiving the page start command.

In the process in Step S36, the application program section 21 outputs drawing data consisting of characters, images and the like to the virtual printer driver 25. In the process in Step S37, the virtual printer driver 25 rasterizes the drawing data after receiving the drawing data, and writes bit map image data into the page memory 28.

It is to be noted that, at the time of the process in Step S36, the application program section 21 calls the data drawing functions in the graphic device interface section 22, and the graphic device interface section 22 calls the data drawing functions in the virtual printer driver 25 corresponding to the called data drawing functions. Thereafter, the application program section 21 generates the drawing data by using the called data drawing functions.

In the process in Step S38, the application program section 21 transmits a page end command to the virtual printer driver 25 after finishing transmission of all the drawing data. Subsequently, in the process in Step S39, the virtual printer driver 25 calculates an area coverage by image forming material by scanning the page memory 28 after receiving the page end command. Then, the virtual printer driver 25 calculates the printing cost for each printing machine by using the print count specified by a user, the area coverage by image forming material, and stored printing cost information, and selects a printing machine of the minimum printing cost depending on the area coverage by image forming material and the print count. It is to be noted that the calculation process of the area coverage by image forming material is similar to that of the first embodiment explained in FIG. 5, and thus explanation will be omitted.

In the process in Step S40, the virtual printer driver 25 opens the printer driver 26a corresponding to the selected printer driver or the printer driver 26b, and in the process in step S41, the virtual printer driver 25 transmits image data to either the printer driver 26a or the printer driver 26b as a process in Step S41. Here, the process in Step S41 is finished, and a series of printing processes are completed.

Here, the transmission process of image data in Step S41 will be executed following the flowchart shown in FIG. 15. First, as the process in Step S51, the virtual printer driver 25 transmits the print start command to either the printer driver 26a or the printer driver 26b. Thereafter, in the process in Step S52, either the printer driver 26a or the printer driver 26b initializes the respective printer driver, either the printer driver 26a or the printer driver 26b, after reception of the print start command.

In the process in Step S53, either the printer driver 26a or the printer driver 26b outputs header information to the spooler 24.

In the process in Step S54, the virtual printer driver 25 transmits the page start command to either the printer driver 26a or the printer driver 26b. Thereafter, as a process in Step S55, either the printer driver 26a or the printer driver 26b allocates the page memory 28 after reception of the page start command.

In the process in Step S56, the virtual printer driver 25 outputs the image data to either the printer driver 26a or the printer driver 26b. Then, as the process in Step S57, either the printer driver 26a or the printer driver 26b writes the image data into the page memory 28 after reception of the image data.

In the process in Step S58, the virtual printer driver 25 transmits the page end command to either the printer driver 26a or the printer driver 26b after finishing of transmission of all the image data. Then, as the process in Step S59, either the printer driver 26a or the printer driver 26b receives the page end command, and after that converts the image data in the page memory 28 to the printer commands, and outputs the printer commands to the spooler 24. When the spooler 24 receives the printer commands, the spooler 24 writes the printer commands in the spool file, and outputs a file to either the printer port driver 27a or the printer port driver 27b.

In the process in Step S60, either the printer driver 26a or the printer driver 26b transmits the page end command to the spooler 24 after finishing output of all the printer commands. Here, a series of transmission processes of the image data are finished.

As has been explained, in accordance with the third embodiment, the virtual printer driver 25 of the PC 7 calculates the area coverage by image forming material. Then, the virtual printer driver 25 calculates the printing cost based on the print count specified by a user, the area coverage by image forming material, and registered printing cost information. Thereafter, the virtual printer driver 25 automatically selects a printing machine of the minimum printing cost from various printing machines with the different unit cost of image forming material. Therefore, the user can reasonably carrying out printing by using the printing machine of the minimum printing cost without awareness.

It is to be noted that in the third embodiment, the virtual printer driver 25 calculates the printing cost for each printing machine, and automatically selects a printing machine of the minimum printing cost. However, a configuration can be adopted so that the user can select a printing machine and the virtual printer driver 25 only calculates the printing cost for each printing machine.

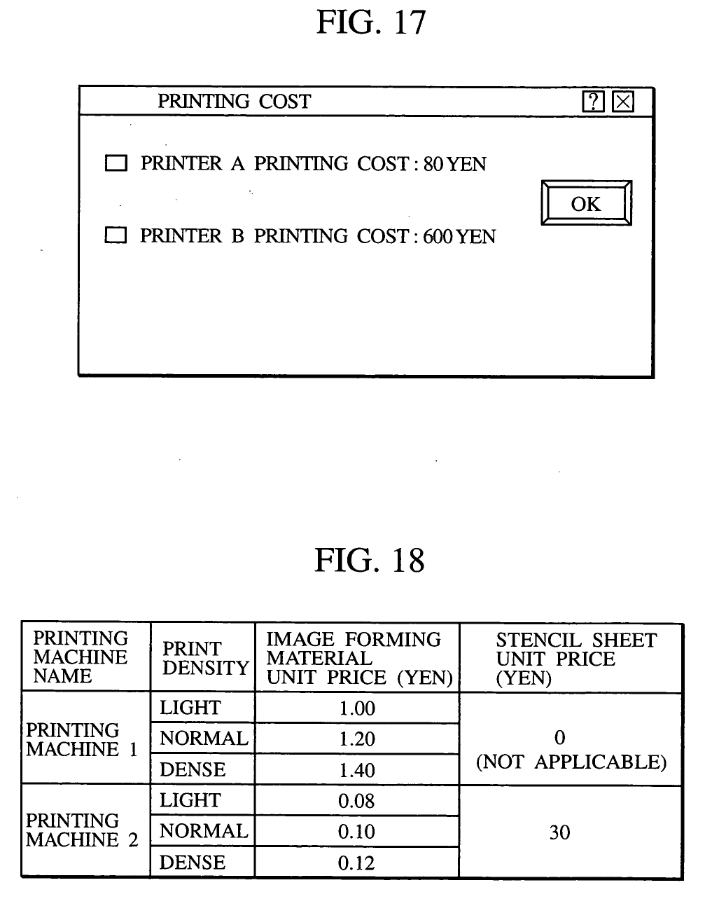

In this case, the virtual printer driver 25 outputs the printing cost for each printing machine on a display as shown in FIG. 17. In FIG. 17, printing machine names are listed in the descending order of the printing cost. The user can select a printing machine used for printing in consideration of conditions, such as the displayed printing cost on the list, several factors required for printed matter, printing speed, printing quality of each printing machine, and the like.

In general, there are many cases that the user does not know a printing cost incurred in printing printed matter even if the user gets hold of knowledge on printing speed and printing quality of each printing machines connected via an electronic network. Therefore, with the configuration thereof, it is made possible for the user to arbitrarily select a printing machine by referring to knowledge on printing speed and printing quality, and the displayed printing cost. Here, the printing machine will satisfy various conditions required for the printed matter.

### Fourth Embodiment

<Configuration of Printing System>

When an information processing apparatus and information processing program of the present invention is applied to a printing system, in which a print density of a printing machine 2 in FIG. 1 is adjustable in three levels, such as “light”, “normal”, and “dense” for example, printing cost information in FIG. 18 is registered in a cost information register section 14.

As apparent from FIG. 18, if the print density is chosen as normal, a selection of a printing machine of the minimum printing cost is considered to be equal to that of the first embodiment in FIG. 8. The explanation of selection of a printing machine of the minimum printing cost is therefore omitted.

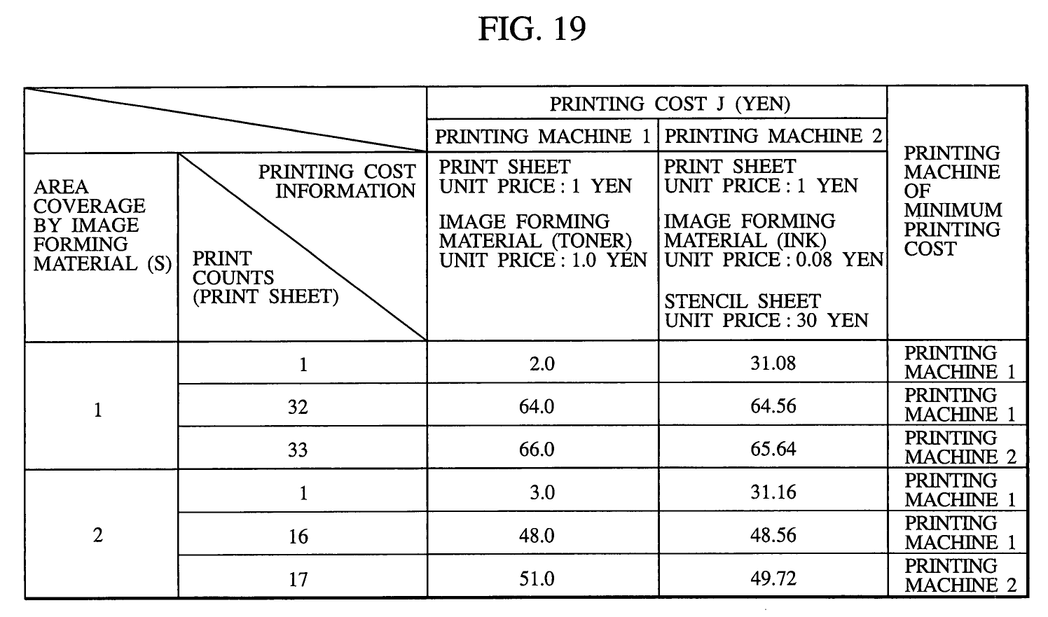

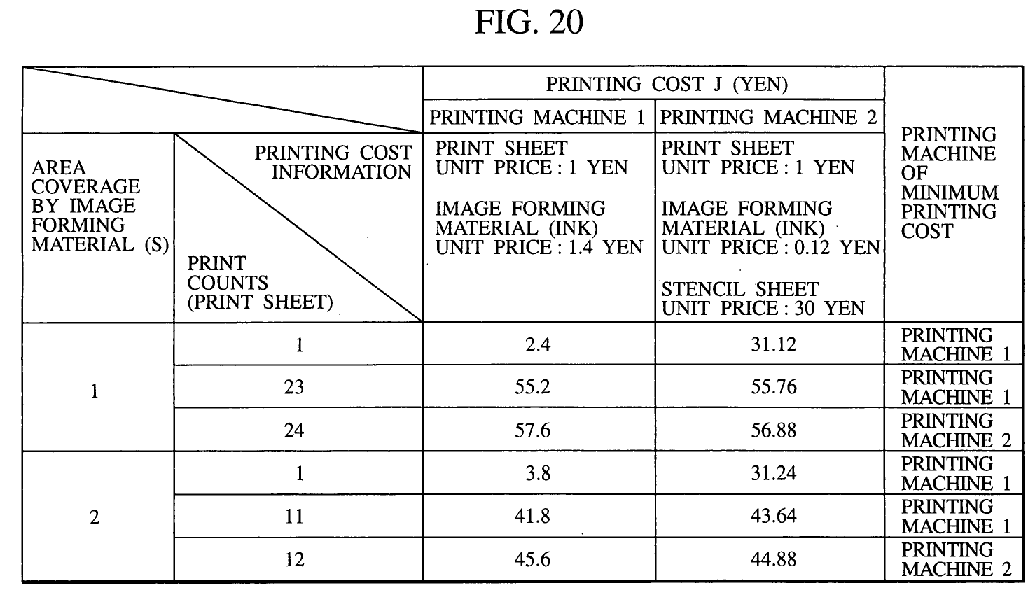

On the other hand, a printing machine of the minimum printing cost can be selected by using FIG. 19 in a case where the print density is chosen as “light”, and by using FIG. 20 in a case where the print density is chosen as “dense”.

Specifically, under the condition that an area coverage by image forming material “S=1”, if the print density is chosen as “light”, a printing machine 1 is selected as a printing machine of the minimum printing cost when a print count is from “1 print sheet” to “32 print sheets”, as shown in FIG. 19. In addition, if the print density is chosen as “dense”, the printing machine 1 is selected as a printing machine of the minimum printing cost when the print count is from “1 print sheet” to “23 print sheets”, as shown in FIG. 20.

As has been shown, it is further made possible to provide the best selection of a printing machine by adding the print density as a parameter for printing cost calculation if the printing system involves printing machines which can set the print density in several levels.

As has been explained hereinbefore, in accordance with the fourth embodiment, a printing cost of each printing machine is calculated based on a print density in addition to an area coverage by image forming material and a print count, and then a printing machine of the minimum printing cost is automatically selected in consideration of the calculated printing cost, it is made possible that a user can execute reasonable printing processes without awareness of the printing cost even if a printing machine having different printing cost depending on the print density exists in the printing system.

### Fifth Embodiment

In the first to fourth embodiments, an image scanner 3 or a PC 7 executes selection processes of a printing machine. However, the selection processes can be executed by a server 8 connected via an electronic network 4.

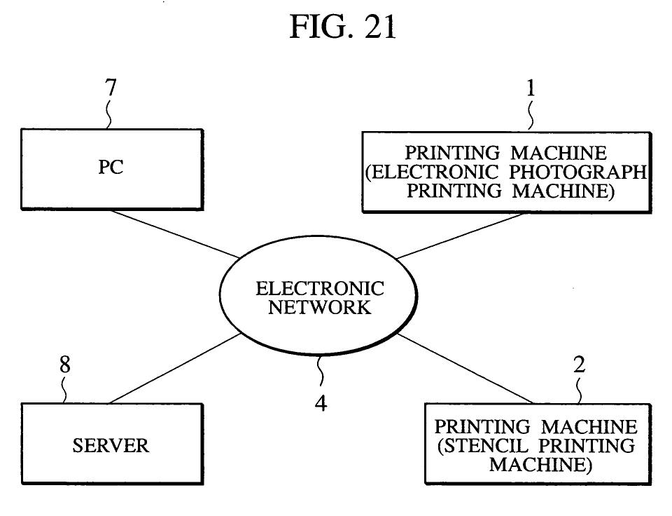

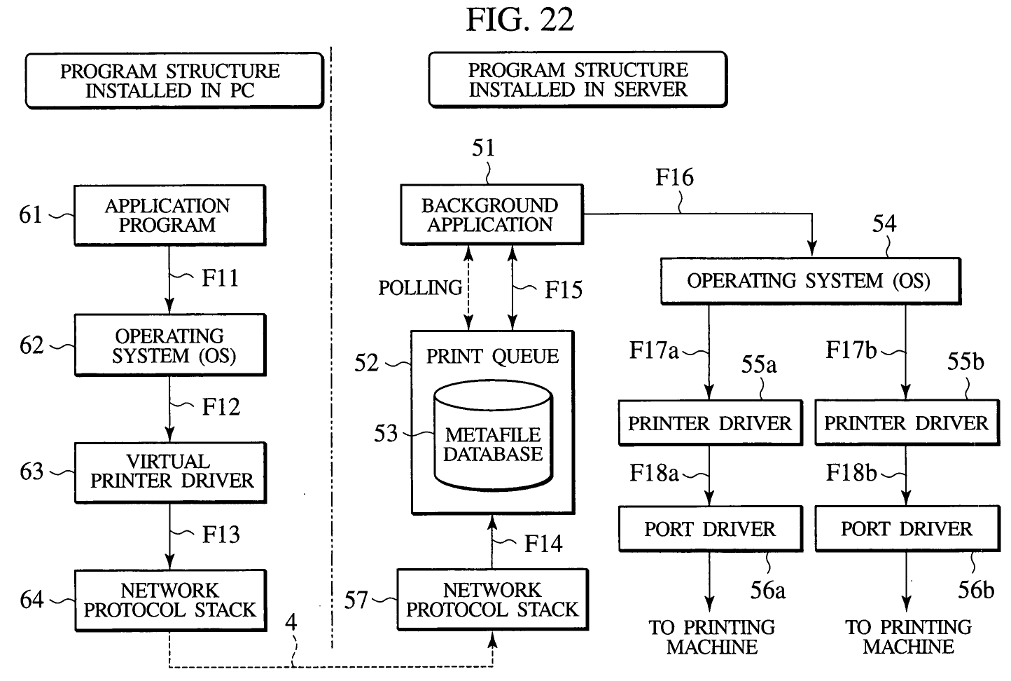

When a configuration of the present embodiment is applied to a printing system as shown in FIG. 11, it is the configuration that the server 8 is connected via the electronic network 4 as shown in FIG. 21. Regarding this system configuration, the constitution of an information processing program installed in the PC 7 and the server 8 is shown in FIG. 22. In this FIG. 22, if a user performs printing processes through the PC 7 via an application program 61 (Arrow “F11” in FIG. 22), an OS (operating system) 62 receives drawing data from an application program 61 and instructs a generation of metafile to a virtual printer driver 63 (Arrow “F12” in FIG. 22).

A metafile is a file of drawing data consisting of description of drawing procedures, such as drawing position command, image drawing commands, text drawing commands.

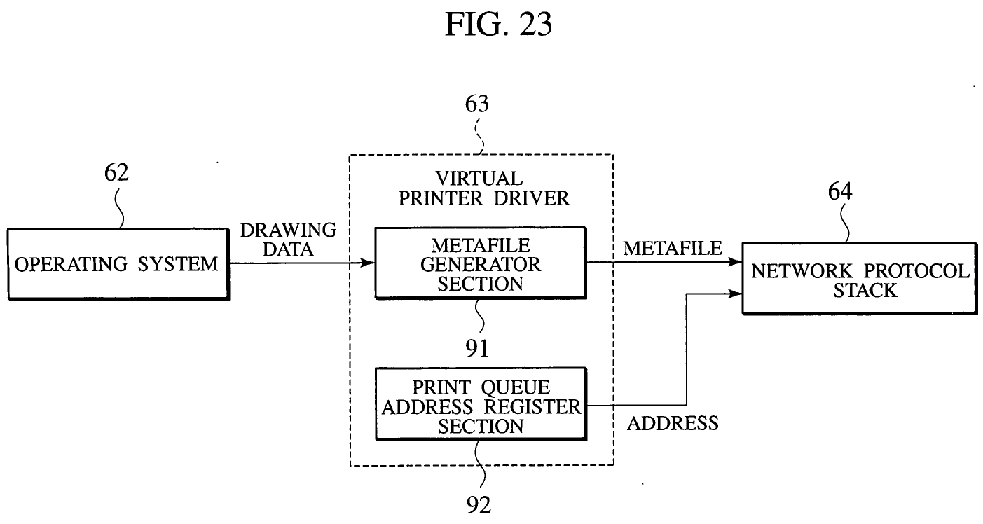

The virtual printer driver 63 consists of a metafile generator section 91 and a print queue address register section 92 as shown in FIG. 23. The metafile generator section 91 generates the metafile from the drawing data.

The virtual printer driver 63 further outputs an address obtained from the print queue address register section 92, in which a destination address of the metafile is registered, and the above generated metafile to a network protocol stuck 64 (Arrow “F13” in FIG. 22). The above address consists of a network address of the server 8 in which a print queue should be registered and an absolute path of the server 8.

The metafile is transmitted to a recording device with the absolute path within the server 8 having the network address. This transmission is realized by communication via the electronic network 4 between the network protocol stuck 64 at the PC 7 side and a network protocol stuck 57 at the server 8 side.

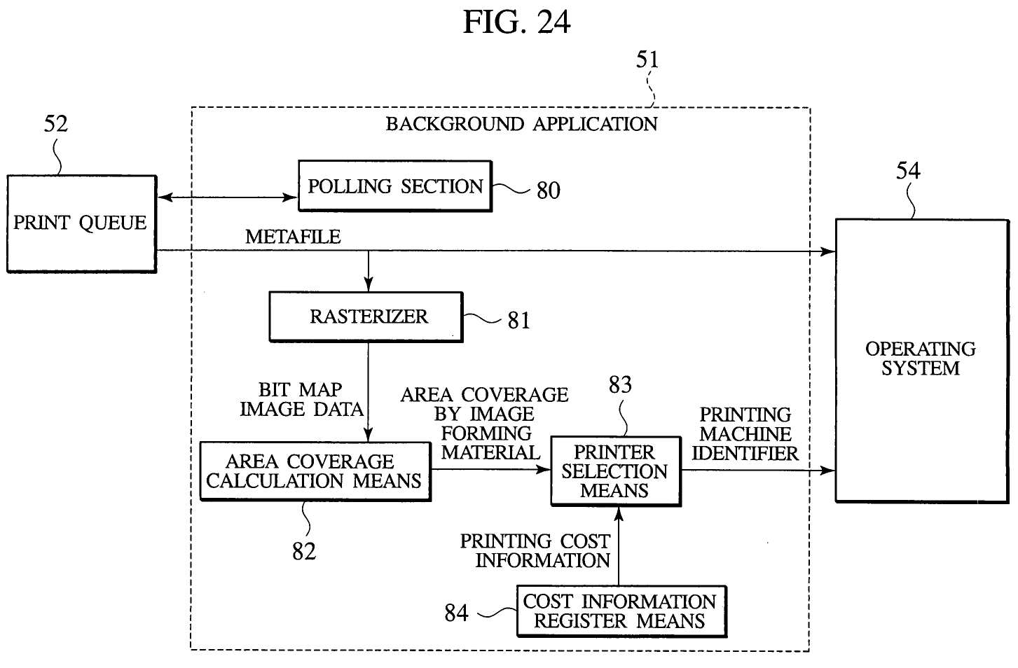

A background application 51 in the server 8 consists of, as shown in FIG. 24, a polling section 80, a rasterizer 81, an area coverage calculation means 82, printer selection means 83, cost information register means 84 and the like.

The polling section 80 executes polling at all times to a print queue 52 and detects existence of the metafile.

The rasterizer 81 rasterizes image data in the metafile and converts to bit map image data. The area coverage calculation means 82 calculates an area coverage by image forming material from the bit map image data converted at the rasterizer 81. Regarding calculation process operation of the area coverage by image forming material at the area coverage calculation means 82 and selection process operation of a printing machine at the printer selection means 83, a explanation thereof is omitted since the process operations are the same as those for the area coverage calculation means 71 and the printer selection means 72 respectively, which are explained in the third embodiment shown in FIG. 13. The printer selection means 83 selects a printing machine of the minimum printing cost based on an area coverage by image forming material, a print count, and cost information registered in the cost information register means 84, and outputs an identifier of the selected printing machine to an OS 54.

The network protocol stuck 57 in the server 8 receives the metafile. Thereafter, by referring to the absolute path, the network protocol stuck 57 writes the metafile in a metafile database 53 in the print queue 52 (Arrow “F14” in FIG. 22).

The background application 51 runs constantly as a background application in the server 8. Thereafter, the polling section 80 of the background application 51 executes polling to the print queue 52 at all times. When the polling section 80 detects the existence of the metafile in the metafile database 53, the polling section 80 reads the metafile (Arrow “F15” in FIG. 22), selects a printing machine of the minimum printing cost, and outputs the printing machine identifier thereof and the metafile to the OS54 (Arrow “F16” in FIG. 22). The background application 51 outputs not the rasterized image data but the metafile to the OS 54. For that reason, the rasterizer 81 of the background application 51 need not rasterize in resolution (about 600 dpi) corresponding to that of the printing machine and may rasterize in the resolution (about 200 dpi) which is sufficient for calculating the area coverage by image forming material.

The OS 54 calls either a printer driver 55a or a printer driver 55b which corresponds to a printing machine selected by the background application 51 (Arrows “F 17a” or “F 17b” in FIG. 22), and outputs the metafile. Either the printer driver 55a or the printer driver 55b which corresponds to the selected printing machine generates printer commands from the metafile, and transmits the printer commands to either a corresponding port driver 56a or port driver 56b (Arrows “F 18a” or “F 18b” in FIG. 22).

In accordance with the fifth embodiment, the load of the PC 7 which is a client of the server 8 can be reduced since the background application 51 of the server 8 executes selection operation process of a printing machine.

Further, the load can be reduced since the virtual printer driver 63 in the PC 7 only convert drawing commands to a metafile and there is no need of rasterizing. Since data in the metafile received by each printer driver are independent of the resolution of the selected printing machine, each printer driver can generate the printer commands in the optimal resolution of the selected printing machine.

Hereinbefore, the detailed explanations have been given of the first to fifth embodiments. The present invention may be carried out in other various forms without departing from the spirit or essential characteristics thereof. The present embodiments are therefore to be considered in all respects as illustrative and no restrictive. The scope of the present invention is indicated by the appended claims rather than by the foregoing description in the specification. Further all variations and changes which come within the meaning and range of equivalency of the claims are therefore intended to be embraced therein.

### INDUSTRIAL APPLICABILITY

According to the present invention, printing processes is performed in reasonable manner by easily and automatically selecting a printing machine for use in printing among a plurality of printing machines within a predetermined budget.

1. An information processing apparatus for transmitting inputted image data to a printing machine connected via an electronic network and making the printing machine execute printing, the information processing apparatus comprising:
a cost information register section for registering printing cost information for each of a plurality of printing machines connected via the electronic network;
an area coverage calculation section for calculating an area coverage by image forming material defined by an area of a print sheet covered with image forming material when printing the image data on the print sheet; and
a printing cost calculation section for calculating a printing cost for printing the image data, based on the area coverage by image forming material, printing cost information for each of the plurality of printing machines, and a print count of the image data.

2. The information processing apparatus according to claim 1, further comprising:
a printing machine selection section which selects a printing machine of the minimum printing cost from among the printing cost of the plurality of printing machines calculated at the printing cost calculation section; and
an image transmission section which transmits the image data to the selected printing machine at the printing machine selection section via the electronic network.

3. The information processing apparatus according to claim 1, wherein the printing cost calculation section calculates the printing cost for printing the image data for each of the plurality of printing machines connected via the electronic network, based on the area coverage by image forming material defined by the area of the print sheet covered with image forming material when printing the image data on the print sheet, printing cost information, the print count of the image data, and a print density of the image data.

4. The information processing apparatus according to claim 1, wherein the area coverage calculation section comprises:
a sampling section sampling the image data at a predetermined sampling space;
a binary coding section converting sampled image data obtained at the sampling section to binarized image data consisting of black pixels and white pixels;
a black pixel counting section counting the number of black pixels of the binarized image data obtained at the binary coding section; and
a black pixel area calculation section calculating the area coverage by image forming material based on the number of black pixels counted at the black pixel counting section, the sampling space, and a resolution of the printing machine.

5. The information processing apparatus according to claim 1, wherein the information processing apparatus is an image input apparatus transmitting the inputted image data from an image reading section to the printing machines connected via the electronic network.

6. The information processing apparatus according to claim 1, wherein the information processing apparatus is a personal computer transmitting the inputted image data from an application program to the printing machine connected via the electronic network.

7. The information processing apparatus according to claim 1, wherein the information processing apparatus is a server transmitting the inputted image data from an application program to the printing machine connected via the electronic network.

8. A computer-readable recording medium on which an information processing program transmitting inputted image data to a printing machine connected via an electronic network and making the printing machine execute printing is recorded, the information processing program causing an information processing apparatus to execute:
a cost information register process for registering printing cost information for each of a plurality of printing machines connected via the electronic network;
an area coverage calculation process for calculating an area coverage by image forming material defined by an area of a print sheet covered with image forming material when printing image data on the print sheet; and
a printing cost calculation process for calculating a printing cost for printing the image data, based on the area coverage by image forming material, printing cost information for each of the plurality of printing machines, and a print count of the image data.

9. The recording medium according to claim 8, wherein the printing cost calculation process calculates the printing cost with the parameters: “J” is the printing cost; “Pₘₐₛₜₑᵣ” is the unit price of a stencil sheet; “P_{print sheet}” is the unit price of the print sheet; “Pᵢₙₖ” is the unit price of image forming material; “S” is the area coverage by image forming material; and “N” is a print count, and with the equation,
J=Pₘₐₛₜₑᵣ+(P_{print sheet}+Pᵢₙₖ×S)×N

10. The recording medium according to claim 8, wherein the information processing program causes the calculated printing cost for each of the plurality of printing machines to be displayed on a display device.

11. The recording medium according to claim 8, wherein the information processing program further causes the information processing apparatus to execute:
a printing machine selection process selecting a printing machine of the minimum printing cost among the plurality of printing machines; and
an image transmission process transmitting the image data to the selected printing machine.

12. The recording medium according to claim 8, wherein the printing cost of printing the image data is calculated based on the area coverage by image forming material defined by the area of the print sheet covered with image forming material on the print sheet, printing cost information of the image data, the print count of the image data, and a print density of the image data.

13. The recording medium according to claim 8, wherein the area coverage calculation process comprises:
a sampling process sampling the image data at a predetermined sampling space;
a binary coding process converting sampled image data obtained by the sampling process to binarized image data consisting of black pixels and white pixels;
a black pixel counting process counting the number of black pixels of the binarized image data obtained by the binary coding process; and
a black pixel area calculation process calculating the area coverage by image forming material based on the number of black pixels counted by the black pixel counting process, the sampling space, and a resolution of the printing machine.

14. The recording medium according to claim 13, wherein the area coverage calculation process calculates the area coverage by image forming material of the image data with the parameters, “S” is the area coverage by image forming material; “A” is a print sheet area; “N_{black-pixel}” is the number of black pixels; “R” is a resolution equivalent to that of the printing machine; “R1” is the resolution of the printing machine; “M” is the sampling space; “L1” is a lateral length of the print sheet; and “L2” is a lateral length of the print sheet, and with the equation
$$S = ( A \times {N}_{black \text{-} pixel} ) / ( L1 \times L2 \times {R}^{2} ) \\ = {N}_{black \text{-} pixel} \times {( M / R1 )}^{2}$$

15. The recording medium according to claim 8,
wherein the information processing apparatus is an image input apparatus transmitting inputted image data from an image reading section to the printing machine connected via the electronic network; and
wherein the information processing program is a firmware program of the image input apparatus.

16. The recording medium according to claim 8,
wherein the information processing apparatus is a personal computer transmitting the inputted image data from an application program to the printing machine connected via the electronic network; and
wherein the information processing program is a virtual printer driver handing over the image data to a printer driver program for a selected printing machine.

17. The recording medium according to claim 8,
wherein the information processing apparatus is a server transmitting the inputted image data from the application program to the printing machine connected via the electronic network; and
wherein the information processing program is a virtual printer driver handing over the image data to the printer driver program for the selected printing machine.

18. A computer program product recorded in which an information processing program transmitting inputted image data to a printing machine connected via an electronic network and making the printing machine execute printing is recorded on a computer-readable recording medium, the information processing program causing an information processing apparatus to execute:
a cost information register process for registering printing cost information for each of a plurality of printing machines connected via the electronic network;
an area coverage calculation process for calculating an area coverage by image forming material defined by an area of a print sheet covered with image forming material when printing the image data on the print sheet; and
a printing cost calculation process for calculating a printing cost for printing the image data, based on the area coverage by image forming material, printing cost information for each of the plurality of printing machines, and a print count of the image data.

19. The computer program product according to claim 18, wherein the information processing program further causes the information processing apparatus to execute:
a printing machine selection process selecting a printing machine of the minimum printing cost among the plurality of printing machines; and
an image transmission process transmitting the image data to the selected printing machine.

20. The computer program product according to claim 18, wherein the printing cost of printing the image data is calculated based on the area coverage by image forming material defined by the area of the print sheet covered with image forming material on the print sheet, printing cost information, the print count of the image data, and a print density of the image data.

21. The computer program product according to claim 18, wherein the area coverage calculation process comprises:
a sampling process sampling the image data at a predetermined sampling space;
a binary coding process converting sampled image data obtained at the sampling section to binarized image data consisting of black pixels and white pixels;
a black pixel counting process counting the number of black pixels of the binarized image data obtained at the binary coding process; and
a black pixel area calculation process calculating the area coverage by image forming material based on the number of black pixels counted at the black pixel counting process, the sampling space, and a resolution of the printing machine.

22. An information processing method, comprising:
registering printing cost information for each of a plurality of printing machines connected via an electronic network;
calculating an area coverage by image forming material defined by an area of a print sheet covered with image forming material when printing image data on the print sheet; and
calculating a printing cost for printing the image data, based on the area coverage by image forming material, printing cost information for each of the plurality of printing machines, and a print count of the image data.

23. The information processing method according to claim 22, further comprising:
selecting a printing machine of the minimum printing cost among the plurality of printing machines; and
transmitting the image data to the selected printing machine.

24. The information processing method according to claim 22, wherein the printing cost of printing the image data is calculated based on the area coverage by image forming material defined by the area of the print sheet covered with image forming material on the print sheet, printing cost information of the image data, the print count of the image data, and a print density of the image data.

25. The information processing method according to claim 22, wherein the area coverage by image forming material calculation step further comprises:
sampling the image data at a predetermined sampling space;
converting sampled image data obtained at the sampling process to binarized image data consisting of black pixels and white pixels;
counting the number of black pixels of the binarized image data obtained by the binary coding process; and
calculating the area coverage by image forming material based on the number of black pixels counted by the black pixel counting process, the sampling space, and a resolution of the printing machine.
